(19) United States
(12) Patent Application Publication
(10) Pub. No.: US 2003/0008619 A1
(43) Pub. Date: Jan. 9, 2003

(54) Location-based information service for identifying areas with degraded radio signal strength

(76) Inventor: Raymond J. Werner, Portland, OR (US)

Correspondence Address: SCHWABE, WILLIAMSON & WYATT, P.C., 10260 SW GREENBURG ROAD, SUITE 820, PORTLAND, OR, 97223, US

(21) Appl. No.: 09/898,724

(22) Filed: Jul. 3, 2001

(51) Int. Cl. H04B 17/00

(52) U.S. Cl. 455/67.1; 455/423; 455/67.6

(57) ABSTRACT

A location-based service provides for reception of information that defines one or more geographical regions, and the transmission of information regarding radio reception and transmission in the one or more defined geographical regions. A searchable database may be provided in which information regarding the attributes of radio reception and/or transmission in various geographical regions is stored. In a particular embodiment of the present invention, a graphical presentation can be made to a user that identifies portions of the one or more defined regions that may not have adequate coverage from Global Positioning System satellites and/or may not have coverage by one or wireless communications services providers.

### BACKGROUND OF THE INVENTION

1. Field of the Invention

The methods and apparatus of the present invention relate generally to the field of location-based services, and more particularly to providing information concerning attributes of specific geographic regions.

2. Background

The deployment in modern times of communication satellites in earth orbit, such as those which form the well-known Global Positioning System (GPS), have enabled, first, military systems, and subsequently, commercial systems to use signals from orbiting satellites to determine their location on earth. In this way, the navigation of military and commercial vehicles by automatic guidance systems has been facilitated.

In addition to guidance system applications, signals from the Global Positioning System have been used in conjunction with various hardware and software products for providing terrestrial coordinates to users such as hikers or backpackers who want or need to know their locations. Similarly, fleets of trucks have been equipped with GPS systems so that their location can be determined.

As the application and acceptance of GPS-based location systems has grown, the cost of such GPS hardware and software has begun to decline. With declining prices, it is anticipated that the deployment of such location information resources in a wide variety of electronic products will become feasible.

Unfortunately, the reception GPS signals in adequate strength and/or number is not possible in all geographic regions, for example, inside certain buildings or tunnels. As a consequence, it is not always possible for processing circuitry associated with a GPS receiver to accurately determine the location of the GPS receiver. Similarly, if the location information derived from the GPS receiver is normally communicated to a remote location so as to obtain a location-based service by way of a wireless communication service, and that wireless communication service is unavailable or degraded in a particular geographic region, then the desired location-based service may not be obtained.

What is needed are methods and apparatus for informing a location-based services consumer that such location-based services may not be available in particular geographical regions.

### SUMMARY OF THE INVENTION

Briefly, a location-based service provides for reception of information that defines one or more geographical regions, and the transmission of information regarding radio reception and transmission in the one or more defined geographical regions.

In one aspect of the present invention, a searchable database is provided in which information regarding the attributes of radio reception and/or transmission in various geographical regions is stored.

### BRIEF DESCRIPTION OF THE DRAWINGS

FIG. 1 is a schematic representation of a map displayed via a graphical user interface on a user's computer display, with a user defined boundary, shown in dashed outline form, overlying a portion of the map.

FIG. 2 is a schematic representation of a map displayed via a graphical user interface on a user's computer display, with a user defined boundary, shown in dashed outline form, overlying a portion of the map; and a highlighted region, shown in cross-hatched form, in which radio operation, i.e., transmission and/or reception is problematic.

FIG. 3 is a block diagram representation of a location-aware product equipped with a GPS module that provides location information to the product in accordance with the present invention.

FIG. 4 is a block diagram of a service center that provides location-based services, the service center including a computer system, a database of customer specified geographical boundaries that define particular geographical regions, a database of geographical regions known to have radio transmission or reception problems, and a network interface; and further shows a network communications cloud, and an illustrative computer interfaced to the service center through the communications cloud.

FIG. 5 is a flowchart of an illustrative process in accordance with the present invention that receives boundary information from a service center customer, determines whether there are known radio transmission or reception problems associated with the received boundary information, and transmits, a notice of the known problems, if any.

FIG. 6 is a flowchart of an illustrative process, in accordance with the present invention, that includes updating a database of known poor radio signal conditions, determining if any of the updates affect existing user-defined regions, and sending a message to the affected users.

FIG. 7 is a flowchart of an illustrative process, in accordance with the present invention, that includes updating a database of known poor radio signal conditions, determining if any of the updates affect existing user-defined regions, and sending a message to the affected users.

### DETAILED DESCRIPTION

Generally, one or more geographic regions, defined by a user, are compared to the contents of a database that contains information about radio reception and transmission attributes of a plurality of geographic regions. If the one or more geographic regions, or any part or parts thereof, overlap with regions that have undesirable radio reception and/or transmission characteristics, then a notification may be provided to the user. The notification may be in real-time, or otherwise.

In an illustrative embodiment, a database includes information on areas where GPS signals or transceiver signals to/from a remote unit are blocked or degraded, for example, in railroad tunnels or particular buildings. When a user of a location-based service defines a boundary, the system graphically highlights those portions of the user-defined region for which service coverage is unreliable or unavailable.

A database that contains information about radio reception and transmission attributes of a plurality of geographic regions can be built by making measurements of pertinent radio reception and transmission characteristics in a plurality of locations, making estimates of radio reception and transmission characteristics based on knowledge of building locations in urban areas, placement of cellular towers, cellular coverage maps of various wireless services providers, by learning of exceptions to presumed good radio coverage, or a combination of one or more of the foregoing. Data regarding the regions of undesirable coverage are typically stored in the form of polygon information, however any suitable means of storing such data may be used by the present invention as long as the information may later be accessed and compared to information defining other geographic or geographical and temporal regions.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

In an illustrative location-based service that would benefit from various embodiments of the present invention, users specify geographic regions to a service center for use in connection with mobile location-aware products. In such a scenario, the location-aware product typically receives signals from GPS satellites, determines its location, and communicates its location to the service center. At the service center, the location coordinates of the location-aware product are compared to the user specified geographic regions. Depending on whether the location coordinates received from the location-aware product are inside or outside of the specified geographic regions, various actions, specified by the user, may be initiated by the service center.

In the above-described illustrative location-based service, users typically specify the geographic regions by interacting with a graphical user interface in which drawing of a boundary on a map is performed. The boundary, which defines a region, is communicated to the service center. The definition of these geographical regions may also be accomplished by various alternative ways, such as, but not limited to, (1) defining a path rather than a boundary, wherein the path is associated with a width so as to define a region, and defining the path may include a drawn path or a series of click points on the map made in the GUI from which the path is determined; (2) specifying points and radii so as to define circular regions; or (3) defining the regions via a voice interface wherein coordinates for a boundary are determined from spoken descriptions of a polygon's vertices.

In one embodiment of the present invention, after receiving information from a user that defines a geographical region, that region is compared with at least a portion of the contents of a database of geographical regions having known problems with radio reception or transmission. If an overlap is found between the user-defined geographical region and one or more regions in the database of known problem regions, then a notification is provided to the user. For example, if the user defines a geographical region by means of drawing a boundary on a map in a GUI, and the defined geographical region includes a railway tunnel in which it is known that GPS signals cannot be received, then the service center communicates a notification to the user that at least that portion of the user defined geographical region cannot, or may not, function as desired. In one embodiment of the present invention, the communication of the notification takes place by downloading to the user, a map showing at least that portion of the user defined geographical region in which problematic radio performance occurs. Similarly, a text-based message may be sent to the user, or a message that combines both graphics and text.

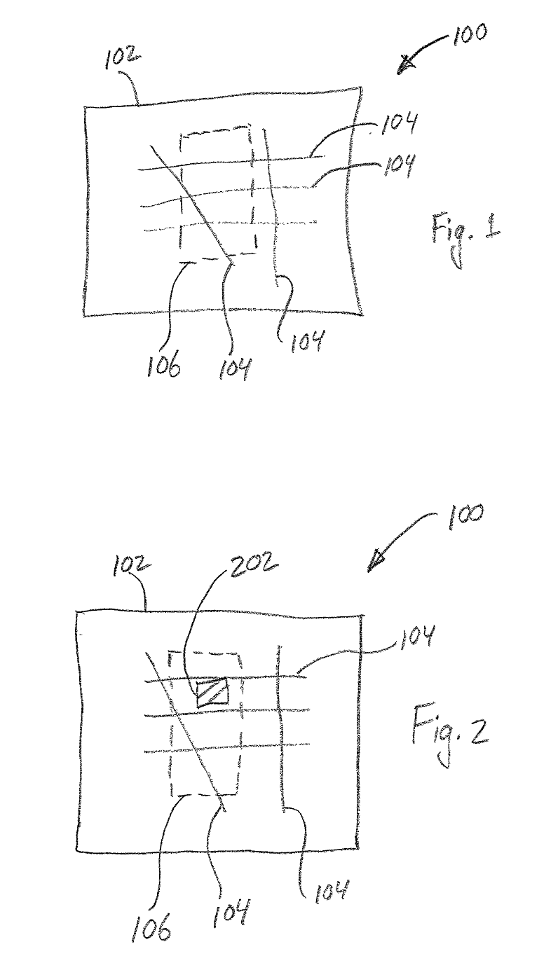

FIG. 1 is a schematic representation of a map displayed via a graphical user interface on a user's computer display, with a user defined boundary, shown in dashed outline form, overlying a portion of the map. More particularly, a GUI 100 displays therein a map 102, which includes typical landmarks such as streets 104. Displayed map 102 also includes a user-defined boundary 106. Typically, information that represents the pixel coordinates of the user defined boundary is communicated to a location-based services center where a determination is made as to the actual geographical coordinates represented by the pixel coordinates of the user defined boundary obtained from the user's GUI. Such communication typically occurs when the user submits the boundary information to the service center. Communication of information from a client computer to a server computer, for example from a personal computer coupled to the Internet and executing web browser software, to a web server computer also coupled to the Internet, is well understood in the field of computer communications, and is not described in greater detail herein.

FIG. 2 is a schematic representation of a map displayed via a graphical user interface on a user's computer display, with a user defined boundary, shown in dashed outline form, overlying a portion of the map; and a highlighted region, shown in cross-hatched form, in which radio operation, i.e., transmission and/or reception is problematic. More particularly, FIG. 2 illustrates GUI 100 displaying map 102, which includes landmarks such as streets 104, user-defined boundary 106, and a so-called “black-out” area 202. Black-out area 202 provides notice to the user that at least that portion of the user defined region may have problems in terms of the desired location-based services in that blacked-out portion. As mentioned above, it is also contemplated that text-based messages be made available for downloading to the user's computer display. It will be understood, that although this illustrative embodiment is described in terms of a computer, any device having the appropriate level of computational resources can be used, notwithstanding that the device might be used primarily as a game platform, wireless telephone, or other such consumer electronics device.

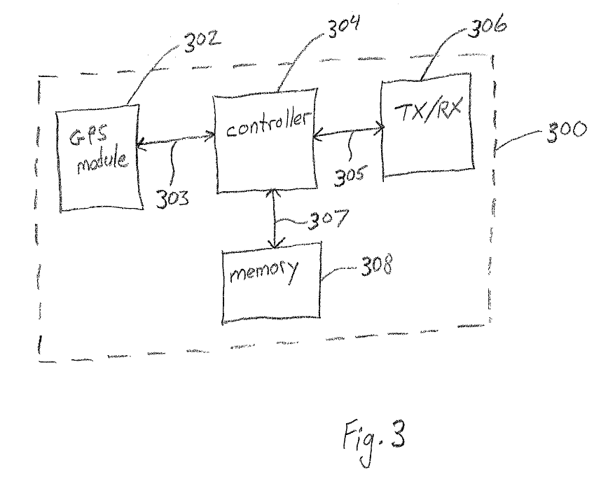

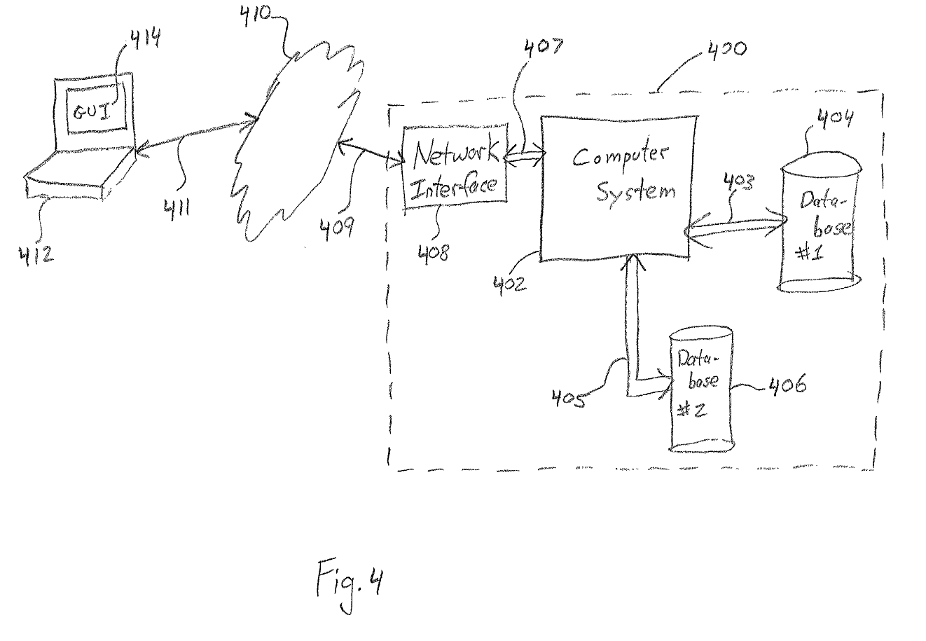

FIGS. 3 and 4, described more fully below, show illustrative embodiments of a location-aware product, and a location-based services center communicatively coupled to a computer from which data can be received in connection with user defined geographical regions.

FIG. 3 is a block diagram representation of a location-aware product equipped with a location information resource, such as a GPS module, that provides location information to the location-aware product. More particularly, a GPS module 302 is shown coupled to a controller 304 by way of communication path 303. GPS modules are commercially available from a number of manufacturers. An antenna suitable for receiving GPS signals is typically included within GPS module 302, but such antenna may be spaced apart from location-aware module 302. If the antenna is spaced apart from GPS module 302, then the antenna is appropriately coupled to GPS module 302. In the illustrated embodiment, GPS module 302 includes a GPS receiver and processing circuitry to convert the received GPS signals into location coordinates, such as, but not limited to, latitude and longitude. Communication path 303 may be any suitable means of providing communication between GPS module 302 and controller 304. For example, communication path 103 may be, but is not limited to being, a direct, wired connection to Input/Output (I/O) ports of controller 304, or a shared bus connection to controller 304. Controller 304 is typically an integrated circuit referred to in the field as an embedded microcontroller. Alternatively, it may be a microcontroller, and microprocessor, an application specific integrated circuit (ASIC), or any other type of processor generally capable of executing a stored program. Controller 304 is coupled to a transmitter/receiver (TX/RX) 306 by way of communication path 305. Communication path 305 may have the same architecture and attributes as communication path 303 described above. TX/RX 306 may be any radio circuitry capable of receiving signals representative of commands from a remote site and transmitting location information to a remote site. Typically, TX/RX 306 is similar, or identical to the radio portion of a cellular telephone. Various cellular telephone protocols and radio frequencies may be used in connection with the present invention. In other words, the present invention is not limited to any particular protocol or frequency. Location-aware product 300, having a cellular phone mechanism incorporated therein for communication with the service center typically requires that a particular cellular communications service provider be engaged to provide “airtime”.

Still referring to FIG. 3, controller 304 is also coupled to a memory 308, by way of a communication path 307. Communication path 307 may be as described above in connection with communication paths 303 and 305. Memory 308 may be any suitable memory for use with controller 304, such as, but not limited to, static RAM, dynamic RAM, flash, ROM, or various combinations of the aforementioned memories.

Continuing to refer to FIG. 3, it should be noted that reading location information from GPS module 302 is similar to reading information from any commonly available type of computer peripheral device. For example, one or more fixed addresses in a memory, or I/O space, may be read and the resulting data represents the location information. In an alternative embodiment, a command is written to GPS module 302 and as a consequence, location information is transferred by GPS module 302 to some pre-determined address. Those skilled in the art will appreciate that a variety of communication pathways and methods to transfer information between a peripheral device such as GPS module 302, and controller 304, are well known and understood in this field.

FIG. 4 is a block diagram of a service center, in accordance with the present invention, that provides location-based services, the service center including a computer system, a database of customer specified geographical boundaries that define particular geographical regions, a database of geographical regions known to have radio transmission or reception problems, and a network interface; and further shows a network communications cloud, and an illustrative computer interfaced to the service center through the communications cloud. More particularly, illustrative service center 400 includes a computer system 402 coupled to a first database 404 by means of communication pathway 403. The information contained in database 404 is typically stored on one or more hard disk drives, but any suitable memory storage medium can be used. Database 404 may be flat, relational, or conform to any other database architecture. Database 404 as used in this illustrative embodiment of the present invention, contains information in connection with various regions in which radio performance issues may prevent the location-based service from being properly executed. For example, database 404 may contain polygons representative of terrestrial geographical regions in which reception of GPS signals of adequate signal quality or number cannot be achieved, or cannot be achieved reliably. Communication pathway 403 is typically a parallel bus of electrical conductors, but any suitable means of transferring information from database 404 to computer system 402 may be used. Computer system 402 is further coupled to a second database 406 by means of a communication pathway 405. The information contained in database 406 is typically stored on one or more hard disk drives, but any suitable memory storage medium can be used. Database 406 may be flat, relational, or conform to any other database architecture. Database 406 as used in this illustrative embodiment of the present invention typically contains representations, such as but not limited to, polygon vertices, of geographical regions specified by a user or customer of the location-based service. Communication pathway 405 is typically a parallel bus of electrical conductors, but any suitable means of transferring information from second database 406 to computer system 402 may be used. Furthermore, databases 404 and 406 may be stored on the same disk drive and access to those databases may be via the same communication pathway.

Still referring to FIG. 4, a network interface is shown coupled to computer system 402 by means of communication pathway 407. Network interface 408 may be any suitable means of providing information transfer, i.e., sending and receiving, for computer system 402. In an illustrative embodiment, network interface 408 is an Ethernet-based interface to a local area network. The local area network, through various know hubs, bridges, switches and routers, which make up communication cloud (sometimes referred to as a communications fabric) 410, provides access to sources of incoming information, and to destinations for outgoing information. Various other network interfaces, such as but not limited to telephone modems, cable modems, and the like, are well known in this field and not further described herein.

FIG. 4 also shows communications cloud 410 connected to a computer 412 executing software that provides graphical user interface (GUI) 414. In an illustrative embodiment of the present invention, a user may communicate with service center 400 through GUI 414 running on computer 412. One specific form of communication between the user and service center 400, is the specification of boundaries that define one or more geographical regions. Such geographical boundary information is typically stored in second database 406. The specification of boundaries may be achieved by receiving from the user's GUI the pixel coordinates that are necessary to specify the boundary drawn on a particular view of a map displayed to the user. The pixel coordinates can then be processed at the service center using knowledge of the map and the scale factor at which it was displayed. Such processing is typically implemented in software running on a computer at the service center.

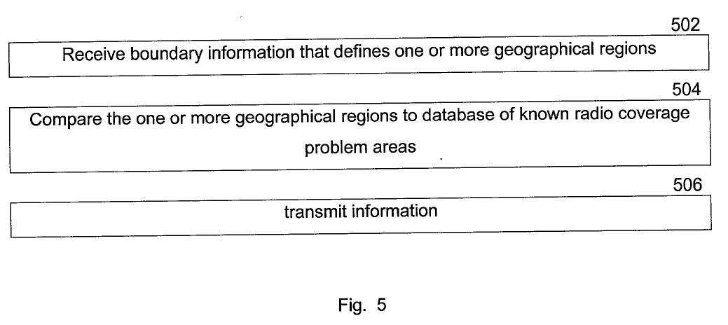

FIG. 5 is a flowchart of an illustrative process, in accordance with the present invention, that receives boundary information from a service center customer, determines whether there are known radio transmission or reception problems associated with the received boundary information, and transmits, a notice of the known problems, if any. More particularly, a service center, such as that illustrated in FIG. 4, receives boundary information that defines one or more geographical regions 502. The one or more geographical regions defined by the received boundaries are compared to one or more geographical regions stored in a database of known poor radio signal condition regions 504. This database of known poor radio signal condition regions may be implemented as described in connection with database 404 shown in FIG. 4. If there is an overlap between one or more of the geographical regions defined by the received boundaries, and the one or more of geographical regions stored in the database, then an output is generated which represents the union (i.e., the logical AND) of the two sets of geographical regions. Another way of describing this, is that determining whether there is an overlap involves evaluating the results of the logical AND operation, and if the result of the logical AND operation is not a null (i.e., not the empty set) then the determination is affirmative.

Still referring to FIG. 5, information concerning the logical AND of the two sets of geographical regions is then transmitted 506 to a customer of the location-based service provided by the service center. This information may be a notification that service may not be available due to poor GPS reception, or poor, or unavailable, wireless service between the location-aware product and the service center from within the identified portion or portions of the user-defined region. The notification may take the form of an updated map display in the user's GUI wherein the black-out areas are graphically highlighted.

Still referring to the illustrative embodiment shown in FIG. 5, the database of known poor radio signal conditions may also be referred to as a database of “blacked out” areas. These blacked out areas are geographic regions in which the location-based service may not be available, may not function properly, or may only function intermittently or unreliably. For example, if the location-based service requires a GPS-based location-aware product to communicate its location to the service center, and the area of operation defined by the user specified boundaries includes at least a portion in which GPS signals of adequate quality and number are not available, then the user can receive a notice from the service center that the user defined geographic region has at least some portion in which the location-based service will not function properly, or may not function at all. Typically, the overlap, if any, between the user-defined region or regions and the blacked out regions is determined by way of software that executes on computer system 402 of service center 400. Software, and software methods, for combining, comparing, and performing logical operations on databases of polygon data have been known for many years (e.g., software used in the electronics industry to combine, compare, and perform logical operations upon the polygons of mask layout databases for integrated circuits), and are not described in significantly greater detail herein.

With respect to the notification, which may be text-based, audio-based, graphics-based, video-based, or any combination of the foregoing, it should be noted that separate notifications may be provided for GPS reception problems, and airtime service provider problems. The problems with separate causes may be shown graphically by highlighting the various problem regions with colors that can be arbitrarily assigned to the different problem causes. For example, regions having GPS reception problems may be highlighted in one color or pattern, and regions having wireless communication problems may be shown in another color or pattern. On the other hand, all such problem areas may also be shown to the user with or without distinguishing the root causes. As noted above, such notifications to the user can take any form whether text, audio, graphics, video, or any other suitable medium.

Additionally, the database of known poor radio condition regions may include regions having temporal attributes associated therewith. That is, in some instances it may be known that, for example, wireless communication service in a particular region will be unavailable during one or more certain time periods. The information concerning the specific time intervals of such service outages can also be sent to a user that has defined a region that overlaps with the black-out area having specific temporal data associated therewith.

As mentioned above, a typical implementation of a location-aware product suitable for use with the location-based service, uses the cellular telephone network for wireless communication service. It should be noted that cellular coverage (i.e., the infrastructure necessary for a cellular telephone to connect through a base station with the public switched telephone network, or any other network), although widespread, has gaps in the coverage areas for various ones of the cellular service providers. Because of this, location-aware products may be manufactured using different cellular telephony protocols, and may have “airtime” services provided by different cellular telephone companies. When a location-aware product is registered with (i.e., subscribes to the services of) the location-based services provider, which is typically, but not required to be, different from the airtime services provider, the location-services provider collects information regarding the airtime service provider for each location-aware product. The location-based services provider also typically collects coverage maps from the airtime service providers.

By knowing the airtime service provider used by each subscriber, and knowing the coverage of the cell zones of the various airtime providers, the location-based services provider can alert a subscriber, to the fact that the subscriber is attempting to define one or more regions in which the location-aware product will not be able to communicate, or not be able to communicate reliably, with the service center. (Subscribers may also be referred to herein as users.) It is desirable to able to distinguish between the various wireless communication services providers, otherwise a subscriber might receive notice of a gap in coverage that does not apply to their particular wireless communication services provider.

It is also preferable to wait for a subscriber to define a region and then communicate notice of service outage areas to the subscriber, because in many instances a particular customer may not be affected by a particular outage and therefore a cleaner, clearer, easier to use map can be presented to the user for initial specification of a geographic region. It should also be noted that the subscriber can associate temporal coordinates with geographic points and/regions and therefore notification regarding scheduled outages that are known to be outside the scope of the user's boundary definition do not need to communicated to the user. Although, an additional service can be provided to the user wherein all or a portion of the contents of the black-out database be received, in any suitable format. The location-services provider can charge an additional service fee for providing such content to a user, or may provide the content without charge.

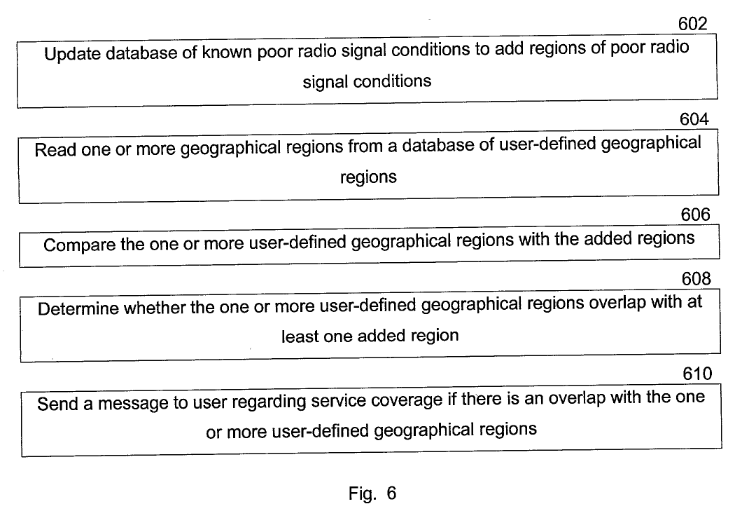

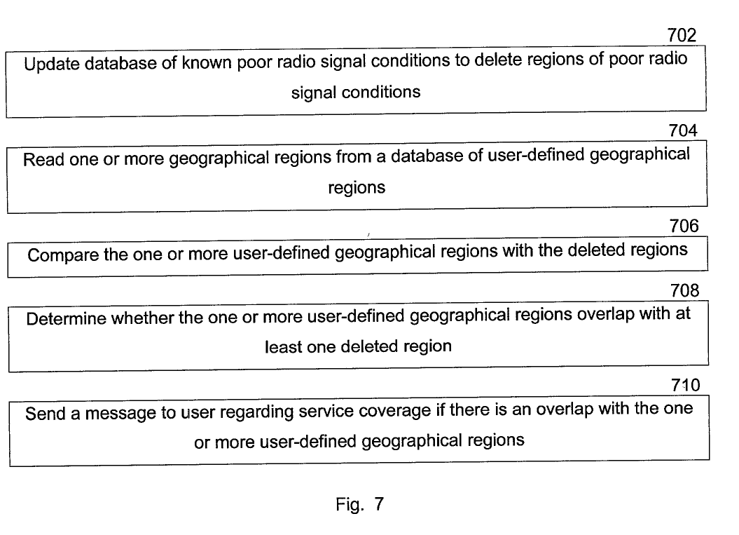

FIGS. 6 and 7 are flowcharts of processes, in accordance with the present invention, that can be used to notify a user of changes in GPS coverage or changes in wireless communication services coverage that occur after a user-defined region or regions has been established. In that sense, these are “off-line” processes in which a user does not need to be actively engaged in defining a geographic region or regions.

FIG. 6 is a flowchart of an illustrative process, in accordance with the present invention, that includes updating a database of known poor radio signal condition regions, determining if any of the updates affect existing user-defined regions, and sending a message to the affected users. More particularly, a database of known poor radio signal condition regions is updated 602 to add regions of poor radio signal conditions. One or more geographical regions are then read, or otherwise accessed, from a database of user-defined geographical regions 604. The one or more user-defined geographical regions are compared with the added regions 606. A determination is then made 608 as to whether the one or more user-defined geographical regions overlap with the added regions. If the determination is affirmative, that is, there does exist an overlap between one or more user-defined geographical regions and at least one added region, then a message is sent to the user. The message may be sent as an email, a telephone a page to a wireless pager, a facsimile (FAX) transmission, a posting to a web site, a printed notice, or any other form of communication. A subscriber may specify to the location-based services provider the method of communicating such information to the subscriber.

FIG. 7 is a flowchart of an illustrative process, in accordance with the present invention, that includes updating a database of known poor radio signal condition regions, determining if any of the updates affect existing user-defined regions, and sending a message to the affected users. The embodiment shown in FIG. 7 is similar to that of FIG. 6 but deals with updates in connection with the expansion of service coverage. More particularly, a database of known poor radio signal conditions is updated 702 to delete regions of poor radio signal conditions. In other words, regions that were previously marked as being unable to receive adequate GPS, or airtime coverage, have been determined to have acceptable radio signal conditions for proper operation of location-aware products that subscribe to the location-based service. One or more geographical regions are then read from a database of user-defined geographical regions 704. The one or more user-defined geographical regions are compared with the deleted regions 706. A determination is then made 708 as to whether the one or more user-defined geographical regions overlap with the deleted regions. If the determination is affirmative, that is, there does exist an overlap between one or more user-defined geographical regions and at least one added region, then a message is sent to the user 710. As noted in connection with the embodiment shown in FIG. 6, the message may be sent as an email, a telephone a page to a wireless pager, a facsimile (FAX) transmission, a posting to a web site, a printed notice, or any other form of communication. A subscriber may specify to the location-based services provider the method of communicating such information to the subscriber.

In any of the methods described in connection with FIGS. 5-7, various embodiments may implement indexing, or partitioning, of the black-out database in order to provide for quicker searches. By way of example, and not limitation, collections of information related to coverage gaps in wireless communication services can be organized by wireless services provider. In this way, since the location-based services provider (i.e., the service center) knows which wireless communications services provider a particular subscriber uses a database search may be accomplished more quickly because fewer records need to be searched.

The present invention may be implemented as circuit-based solutions, including possible implementation on a single integrated circuit. As would be apparent to one skilled in the art, various functions of circuit elements may also be implemented as processing operations in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as punched cards, magnetic tape, floppy disks, hard disk drives, CD-ROMs, flash memory cards, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It is to be understood that the present invention is not limited to the embodiments described above, but encompasses any and all embodiments within the scope of the following claims.

What is claimed is:

1. A method of providing notice, comprising:
receiving information representative of a first geographical region;
comparing information representative of the first geographical region to at least a portion of a database, the database containing information representative of a plurality of second geographical regions, the second geographical regions being associated with poor radio signal conditions;
determining if there is an overlap between the first geographical region and one or more of the second geographical regions; and
transmitting, if the determination is affirmative, at least one notification;
wherein the notification contains information regarding the overlap between the first geographical region and the one or more second geographical regions.

2. The method of claim 1, wherein receiving information comprises receiving pixel coordinates.

3. The method of claim 2, further comprising converting the pixel coordinates to polygon specifications.

4. The method of claim 1, wherein the information representative of a first geographical region comprises polygon specifications, and comparing comprises accessing at least a portion of the polygons from the database, and performing a logical AND operation between the polygons from the database and the first geographical region.

5. The method of claim 5, wherein determining if there is an overlap comprises evaluating the results of the logical AND operation and if the result is not null then reporting an affirmative result.

6. The method of claim 1, wherein the notification comprises an image of a map with at least one highlighted portion, the highlighted portion corresponding the a geographical region defined by the logical AND of the first geographical region and at least one polygon from the database.

7. The method of claim 4, the transmitting comprises sending a message to a remote computer.

8. The method of claim 7, wherein the remote computer is the source of the information representative of the first geographical region.

9. A method of advising location-based services clients of changes in coverage, comprising:
updating a database of black-out areas such that a portion of the black-out areas are modified;
comparing the modified areas with a database of client-defined areas;
determining if there is an overlap between the modified areas and the client-defined areas; and
communicating with a client if the determination is affirmative.

10. The method of claim 9, wherein the black-out areas represent regions where GPS signals cannot be received in adequate strength or number by a location-aware product.

11. The method of claim 10, wherein the black-out areas further represent regions where the airtime service required by the location-aware product is not reliably available.

12. The method of claim 11, wherein the black-out areas include temporal information.

13. The method of claim 9, wherein communicating includes one or more of telephoning, paging, faxing, and emailing.

14. The method of claim 9, wherein the modified areas comprise regions of poor radio signal conditions.

15. The method of claim 9, wherein the modified areas comprise regions of good radio signal conditions.

16. The method of claim 14, wherein the regions of poor radio signal conditions comprise regions where GPS signals of adequate strength or number are not available.

17. The method of claim 14, wherein the regions of poor radio signal conditions comprise regions where wireless communications services are unavailable or unreliable.

18. The method of claim 17, wherein the regions of poor radio signal conditions comprising regions where wireless communications services are unavailable or unreliable, further include information regarding a time period during which the wireless communication services will be unavailable or unreliable.

19. The method of claim 9, wherein the database is indexed according to one or more wireless communication service providers.
